(19) United States
(12) Patent Application Publication
(10) Pub. No.: US 2007/0210249 A1
(43) Pub. Date: Sep. 13, 2007

(54) Electron Spectroscope With Emission Induced By A Monochromatic Electron Beam

(75) Inventor: Stefano Giovanni Alberici, Monza (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I, Agrate Brianza(MI) (IT)

(21) Appl. No.: 10/574,868

(22) PCT Filed: Oct. 6, 2004
(86) PCT No.: PCT/IT04/00555

§ 371 Date: Jan. 16, 2007

(30) Foreign Application Priority Data
Oct. 7, 2003 (IT) VA2003A000037

(51) Int. Cl. H01J 47/00

(52) U.S. Cl. 250/305

(57) ABSTRACT

An electroscope system excites a certain area of a surface of a sample to emit electrons with a characteristic distribution of kinetic energies. The analyzed area of the sample is excited by an electron beam produced by a field emission source. A monochromator energy filter for the electron beam is down-stream of the field emission source. The field emission electron source is preferably a Schottky source, and a monochromator energy filter reduces energy dispersion of the electrons of the electron beam to less than 0.2 eV. Microareas of linear dimensions on the order of ten nanometers may be analyzed while observing them. Information on the chemical state of the detected elements present at the surface of the examined microarea of the sample is gathered.

### FIELD OF THE INVENTION

The present invention relates in general to spectroscopy, and more particularly, to a spectroscopic system that analyzes the energy distribution of electrons emitted by a sample suitably excited by irradiation.

### BACKGROUND OF THE INVENTION

Electron spectroscopy analysis is an important technique for investigating solid materials. Basically, there are two types of spectroscopy systems. Each system has peculiar characteristics and features; namely the Auger system and the XPS (X-ray photoelectron spectroscopy) system.

Both types of systems are based on detecting the kinetic energy of electrons emitted from the surface of the sample subjected to bombardment with electrons, or irradiation with X-rays. The energies of the electrons emitted from the surface of the sample are characteristics of the elements and/or compounds present at the surface of the sample.

The Auger system permits inspections to micro-areas of the sample surface down to a minimum linear dimension on the order of hundreds of nanometers, and allows also a SEM (secondary electron microscope) visualization of the inspected area by scanning the area of acquisition of spectrometric data with the focused electron beam.

These systems have the drawback of permitting exclusively an elementary analysis. In other words, they are generally not capable of providing information on the chemical state of the identified elements because of the relatively weak chemical shift to which the Auger electron is subjected.

In contrast, XPS systems offer the possibility of gathering information also on the chemical bonds besides those on the Auger electron. However, the XPS systems do not permit restriction in the area of inspection beyond minimum linear dimensions on the order of hundreds of micrometers because of the difficulty of focusing X-ray beams.

Because of this limitation, this technique is not suited to conduct inspections on microstructures, such as for example, the typical microstructures that are defined by modern fabrication processes of integrated circuits.

Moreover, XPS systems generally do not permit visualization of the inspected area from which spectrometric data are acquired because the X-rays do not lend themselves to be used for scanning the area. Visualization is possible, but at present the common approach remains that of using a dedicated auxiliary SEM column for visualizing the area through the secondary emitted electrons. However, this auxiliary visualization approach is not rigorously tied to the exciting X-ray beam directed onto the sample for the analysis.

It is evident that there is a need and usefulness of a spectroscopic investigation system capable of yielding information also on the chemical state, like a XPS system, but which at the same time would allow one to carry out an investigation on a microspot. The microspot may be on areas having submicrometric linear dimensions, similar to what is possible with the known Auger systems.

It is possible to obtain reliable information on the chemical state, that is on the energy of the chemical bond of an element, by analyzing the kinetic energy distribution of electrons emitted from an irradiated sample, by causing emission of electrons by irradiating the microarea of interest with a substantially monoenergetic electron beam.

Notably, the chemical bond energy (BE) is given by the following relationship:
BE=hv−KE−Ω, (1)
where hv is the energy of the incident particles or photons, KE is the kinetic energy of the emitted electrons, and Ω is the extraction energy. Of course, the higher the resolution of the hv term the more accurate will be the information on the chemical bond.

A beam of sufficiently energetic electrons focused on a relatively small area of interest (microspot) of the surface of the sample may be obtained by using a field emission gauge (FEG) source of electrons and an appropriate energy filter (monochromator) capable of ensuring an energy resolution practically comparable to that of an X-ray monochromator.

Compared to the known systems using a focused electron beam such as the SEM, TEM, Auger and alike systems, all characterized in that they normally use thermo-ionic electron sources (hot sources), such as for example, a hot tungsten source or a hot LaB₆ source, there are others electron sources ideally suited to applications requiring a high spatial resolution. Field emission electron sources such as Schottky and cold-cathode sources have dimensions that generally are between a few nanometers in the case of a cold-cathode source, and about 15 nanometers in the case of Schottky sources. These dimensions are far smaller than those of the commonly use hot tungsten or LaB₆ sources that are on the order of at least 10.000 nm, and normally much larger.

In addition, Schottky emission and cold cathode emission sources have the advantage of a reduced energy dispersion of the emitted electrons, generally less than 1 eV, and a high brightness that may be even several orders of magnitude greater than that of the hot cathode sources of LaB₆ or tungsten. Generally the brightness of Schottky or cold cathode sources is greater than 10⁸ A/cm² SR.

### SUMMARY OF THE INVENTION

In view of the foregoing background, an object of the present invention is to provide a spectroscopic system that yields information on the chemical state of a sample but at the same time allows an investigation to be conducted on a microspot.

A Schottky source is preferable compared to a cold cathode source because a Schottky source, besides the low energy dispersion characteristic and high brightness, is easier to use and has an outstanding short term stability of the electronic current of the beam, which is generally lower than 1% RMS.

Moreover, it is essential to employ an energy filter for the electron beam being focused on the surface of the sample under examination. Energy filters are often called monochromators, and their figure of merit is the smallest energy dispersion they are able to ensure in the filtered beam in order to convey onto the sample to be analyzed a focused electron beam having substantially a planar wave front.

The are several known techniques for monochromatizing an electron beam. Most commonly, the approach is that of applying a magnetic-electrostatic correction to the trajectory of an electron traveling through a certain spatial region that may be semispherical (HEA—hemispherical energy analyzer) [1], or having a quadruple structure (Wien filter, possibly in cascade) [2], [3], known also as mandolino [4], or as typically implemented in transmission electron microscopes (TEM) for conducting EELS (electron energy loss spectroscopy) studies (troncoidal monochromator TM) [5], wherein, always by electromagnetic lenses, electrons of a defined kinetic energy are gathered and exit the monochromator.

There are a number of monochromator filters for electron beams described in the literature. Basically, all these filters are based on the principle that electrons that do not possess the selected kinetic energy are electromagnetically deflected over different trajectories from the trajectory of electrons having the desired kinetic energy, which normally coincides with the central axis of the deflecting device. The deflected electrons are eventually suppressed by collecting them on a collector, or in some cases, electrons are re-focalized by guiding them along an appropriately designed path so that they emerge from the spatial sector relative to the desired kinetic energy value.

The energy dispersion in the electron beam that may be obtained by employing such a monochromator filter for electron beams may be practically reduced to a fraction of eV, and that under such conditions, the monochromatized electron beam is suitable to produce the required analytical results.

Even the level of electronic current that may be obtained through these monochromators, which normally may reach up to about ten nA, is satisfactory to meet the objective of the invention.

The spectroscopic system in accordance with the invention not only has the ability to determine the chemical bond existing among elements present on the microarea scanned by the monochromatic electron beam of excitation of the sample, but also permits visualization of the scanned area in a way that is similar to what happens in a known Auger system. In contrast, an Auger system is unable to provide information on the chemical state of the detected elements.

### BRIEF DESCRIPTION OF THE DRAWINGS

FIG. 1 is a basic diagram of a spectroscopic analysis system in accordance with the invention.

FIGS. 2, 3 and 4 are spectrograms obtained from preliminary tests that demonstrate the effectiveness of the method in accordance with the invention.

### DETAILED DESCRIPTION OF THE PREFERRED EMBODIMENTS

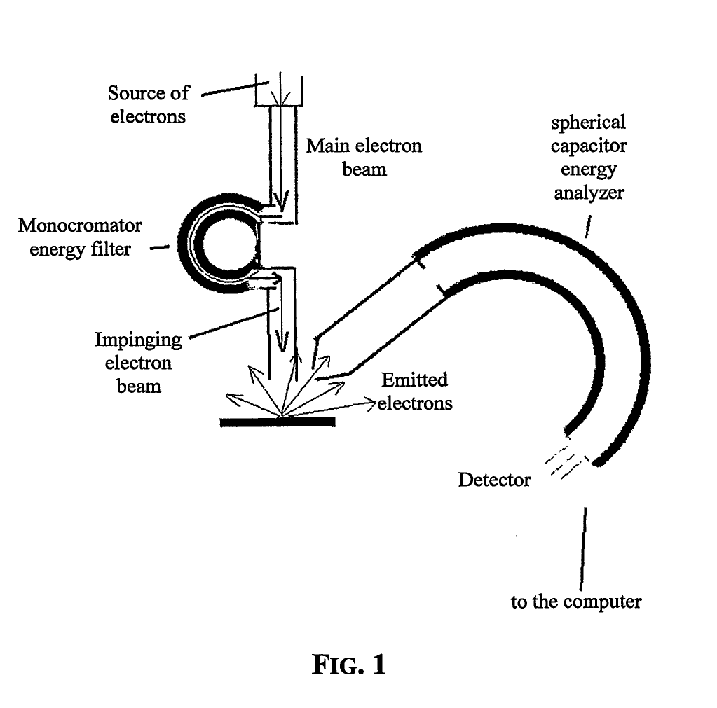

FIG. 1 is a basic diagram of an electron spectroscope implementing the invention. The field emission electron source is preferably a Schottky emission source. For example, the field emission electron source may be of the type produced by the company FEI of the Philips group or by the Japanese company Denka.

The monochromator energy filter of the focused electron beam may be any commercially available filter capable of ensuring a maximum energy dispersion of the electrons of the beam exciting the filter of less than 0.2 eV, and more preferably less than 0.1 eV.

The filtered electron beam is directed on the surface of the sample being analyzed. The irradiated area may have linear dimensions as small as 100 nm, or even less. Of course, scanning a certain area of the sample is done as in any other known focused electron beam system. Analysis of the kinetic energy spectrum of the electrons emitted from the excited area of the sample is carried out with a common spherical capacitor energy analyzer.

Decelerating and focusing of electrons emitted from the excited area of the sample produce a spectrum representative of the distribution of the kinetic energies of the emitted electrons over an inlet aperture of the energy analyzer. A detector detects the electrons traveling through the energy analyzer for reproducing the distribution of the kinetic energies of the emitted electrons along at least a direction orthogonal to the radial direction of said spherical capacitor of the analyzer.

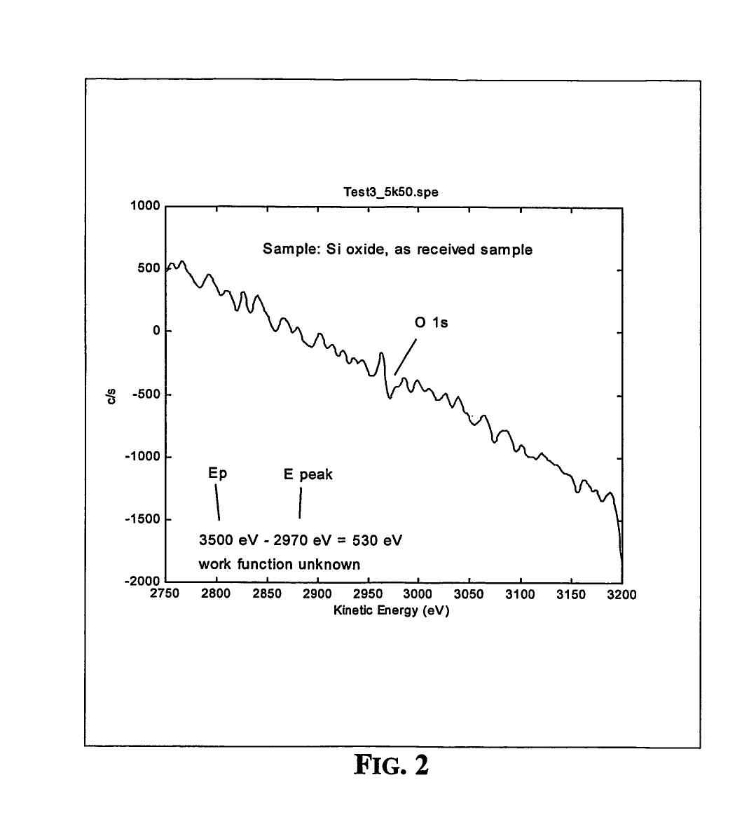

Preliminary tests have been conducted on SiO₂ and Ti samples and the results as shown in FIGS. 2, 3 and 4.

Validity of the approach disclosed herein has been demonstrated by a number of laboratory tests that have been carried out using the available commercial micro Auger system of Physical Electronics, Model 670, notwithstanding that, as with the normally available systems of this type, was equipped with a common electron source of ZrO₂ coated tungsten. The machine had a CMA (cylindrical mirror analyzer) detector, coaxial to the incident electron beam. That is proof of the validity that was sought notwithstanding that a recognizably more effective apparatus using an electron source of reduced energy dispersion was not available.

Different electron accelerating voltages were used, respectively 3.5 and 3.0 kV, with electronic current of about 10 nA, in order to place the shift of the detected peak upon the varying of the accelerating voltage, and to demonstrate the dependence of the position of the peak in the spectrum from the accelerating voltage of the exciting beam.

For a first test, an ultra pure SiO₂ sample of 100 nm of thickness, produced by thermo deposition on silicon was used and the sample had been analyzed without any prior cleaning of the surface, neither by chemical cleaning solutions or ion bombardment.

By observing the obtained spectrogram reproduced in FIG. 2, it may be noted that with an electron beam accelerated at 3.5 kV, a peak appears at 2,970 eV which, from the relationship (1), which yields a BE of 530 eV.

The precise value of the extraction energy (Ω) term should eventually be determined experimentally using appropriate calibration samples. For the purposes of these preliminary tests, the value attributed to it was considered to be a first approximation, missing an absolutely precise value of the term Ω (determined by specific tests) to be used in equation (1). Nevertheless, the result appeared to be very close to the known BE of the oxygen core level is, which in SiO₂ is reported in the literature to be about 533-534 eV. [6].

As commonly done in an Auger system, the spectrum was numerically differentiated in order to give more emphasis to the neighborhood of the detected peak. To further demonstrate the validity of the approach disclosed herein, a different sample of ultra pure titanium deposited on SiO₂ had been used. The sample showed the presence of a superficial film of native titanium oxide.

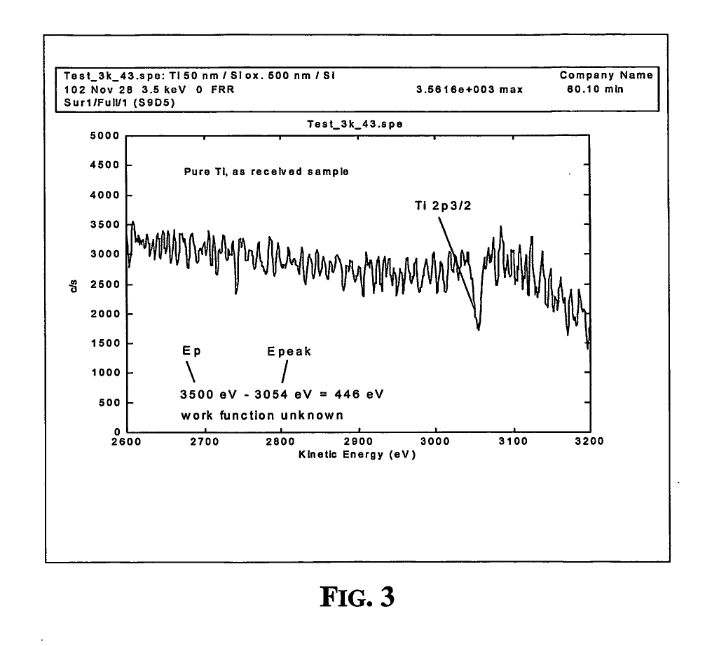

The spectroscopic analysis was carried out under the same experimental conditions of the preceding test, that is, at the same accelerating voltage and electronic current using the same commercially available apparatus without any cleaning of the sample surface. The obtained spectrogram is reproduced in FIG. 3. It may be noted that, with an accelerating voltage of 3.5 kV, a definite peak appears at 3,054 eV, which from the relationship (1), using a first approximation value for the term Ω, yields a BE of 446 eV.

Even in this case the exact value of the term Ω was not determined. Therefore, the attributed value of BE is just a first approximation estimate that comfortably compares with the value of Ti Core 2p 3/2. In literature, it is indicated as being equal to 453-454 eV [6]. Even in this case, a numerical differentiation of the spectrum has been introduced for better detailing the zone of interest.

Finally, it has been proved that the test model in accordance with the invention remains valid not just among different materials but also upon the varying of the accelerating voltage of the exciting electrons. For this purpose, the same Ti sample used in the preceding test has been used to lower the acceleration in voltage from 3.5 to 3.0 kV.

If the test model is valid, then the expectation is that the peak also shifts by a difference equal to the energy difference of the exciting electron beam.

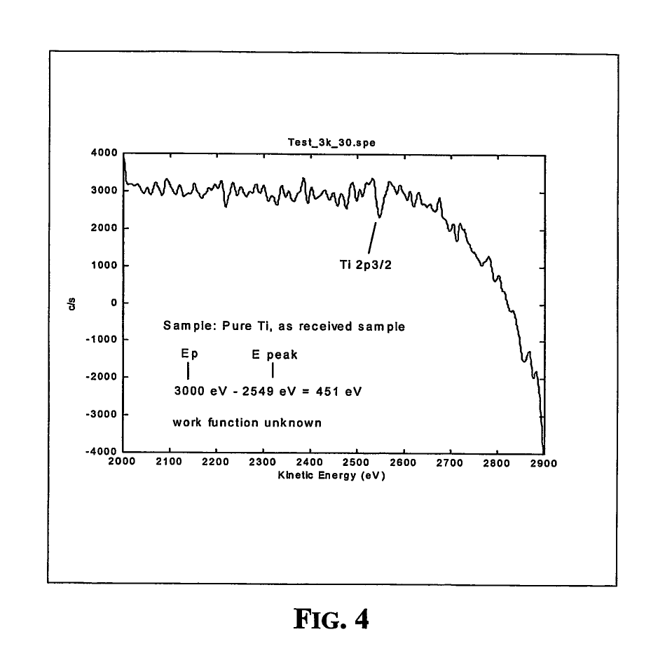

As may be clearly observed in FIG. 4, the result of this further test has been that of an estimated BE of 451 eV, to be compared with the value 453-454 eV reported in the literature [6]. Compared to the preceding test, a change of about 5 eV in the estimated value of the BE is observed (in the preceding test the BE was found to be 446 eV), at the changed accelerating voltage. However, it is to be considered that by decreasing the accelerating voltage the probability of ionizing the substrate decreases, thus implying a lowering of the intensity of the detected signal together with a dispersion thereof. Moreover, it is also possible that by varying the accelerating voltage by 500 eV, the Ω function may itself vary, since this parameter is dependent on the system.

Even though the tests have been carried out using a commercially available apparatus (an Auger system employing a hot cathode electron source) that is not optimized for the test approach in accordance with the invention, and from these tests it may reasonably be deduced that the substrate, whichever it is, has reacted to the external electron excitation by emitting a signal (emitted electrons) that appears to carry information on the superficial chemical state of the detected elements, thus proving the validity of the test approach.

Due to these relative fundamentals of the tests, it has not been possible to obtain relatively large signals confirmed with a higher precision as aligned with the expected data from the literature. However, with the good approximation of the estimate obtained with the basic (not fully optimized) apparatuses, the technique in accordance with the invention will usefully inscribe itself among the known techniques (Auger, EELS and XPS). The technique will be characterized as being able to produce useful information on the chemical state of the detected elements without the limitations of the size of the inspected area of comparable known systems.

### BIBLIOGRAPHY

[1] D. Muigg, G. Denifl, A. Stamatovic, O. Echt, T. D. Maerk, Chemical Physics, 239 (1998) 409-416.
[2] E. Plies, J. Baertle, A. Huber, Europaeische Patentanmeldung EP 1 220 292 A2 (2002).
[3] E. Plies, J. Baertle, Microsc. Microanal. Vol. 9 (suppl. 3) 028 (2003).
[4] E. Essers, B. Huber, Microsc. Microanal. Vol. 9 (suppl. 3) 020 (2003).
[5] V. Grill, H. Drexel, W. Sailer, M. Lezius, T. D. Maerk. J. Mass Spectrom., 2001; 36: 151-158.
[6] Handbook of X-ray Photelectron Spectroscopy, Physical Electronics, Inc., 1995, ISBN: 0-9648124-1-X.

1-2. (canceled)

3. An electron spectroscope comprising:
a field emission source producing an electron beam for exciting a surface of a sample so that electrons are emitted therefrom;
a monochromator energy filter for filtering the electron beam;
a spherical capacitor energy analyzer comprising an inlet receiving the electrons emitted from the excited surface of the sample, with the emitted electrons being decelerated and focused on the inlet and producing a spectrum representative of a distribution of kinetic energies of the emitted electrons over the inlet; and
a detector for detecting the emitted electrons traveling through said spherical capacitor energy analyzer for reproducing the distribution of the kinetic energies of the emitted electrons along at least a direction orthogonal to a radial direction of said spherical capacitor energy analyzer.

4. An electroscope system according to claim 3, wherein said monochromator energy filter reduces energy dispersion of the electrons of the electron beam to less than 0.2 eV.

5. An electroscope system according to claim 3, wherein said monochromator energy filter reduces energy dispersion of the electrons of the electron beam to less than 0.1 eV.

6. An electroscope system according to claim 3, wherein the surface of the sample being excited by the electronic beam has linear dimensions less than or equal to 100 nanometers.

7. An electroscope system according to claim 3, wherein said field emission source comprises a Schottky emission source.

8. An electron spectroscope comprising:
a field emission source producing an electron beam for exciting a surface of a sample so that electrons are emitted therefrom;
a monochromator energy filter for filtering the electron beam;
an energy analyzer comprising an inlet receiving the electrons emitted from the excited surface of the sample, with the emitted electrons producing a spectrum representative of a distribution of kinetic energies of the emitted electrons over the inlet; and
a detector for detecting the emitted electrons traveling through said energy analyzer for reproducing the distribution of the kinetic energies of the emitted electrons.

9. An electroscope system according to claim 8, wherein said detector reproduces the distribution of the kinetic energies of the emitted electrons along at least a direction orthogonal to a radial direction of said energy analyzer.

10. An electroscope system according to claim 8, wherein said energy analyzer comprises a spherical capacitor energy analyzer.

11. An electroscope system according to claim 8, wherein said monochromator energy filter reduces energy dispersion of the electrons of the electron beam to less than 0.2 eV.

12. An electroscope system according to claim 8, wherein said monochromator energy filter reduces energy dispersion of the electrons of the electron beam to less than 0.1 eV.

13. An electroscope system according to claim 8, wherein the surface of the sample being excited by the electronic beam has linear dimensions less than or equal to 100 nanometers.

14. An electroscope system according to claim 8, wherein said field emission source comprises a Schottky emission source.

15. A method for analyzing a surface of a sample comprising:
producing an electron beam with a field emission source for exciting a surface of the sample so that electrons are emitted therefrom;
filtering the electron beam using a monochromator energy filter;
receiving on an inlet of an energy analyzer the electrons emitted from the excited surface of the sample, with the emitted electrons producing a spectrum representative of a distribution of kinetic energies of the emitted electrons over the inlet; and
detecting the emitted electrons traveling through the energy analyzer for reproducing the distribution of the kinetic energies of the emitted electrons.

16. A method according to claim 15, wherein the detector reproduces the distribution of the kinetic energies of the emitted electrons along at least a direction orthogonal to a radial direction of said energy analyzer.

17. A method according to claim 15, wherein the energy analyzer comprises a spherical capacitor energy analyzer.

18. A method according to claim 15, wherein the monochromator energy filter reduces energy dispersion of the electrons of the electron beam to less than 0.2 eV.

19. A method according to claim 15, wherein the monochromator energy filter reduces energy dispersion of the electrons of the electron beam to less than 0.1 eV.

20. A method according to claim 15, wherein the surface of the sample being excited by the electronic beam has linear dimensions less than or equal to 100 nanometers.

21. A method according to claim 15, wherein the field emission source comprises a Schottky emission source.
